(19) United States
(12) Patent Application Publication
(10) Pub. No.: US 2024/0104479 A1
(43) Pub. Date: Mar. 28, 2024

(54) REAL-TIME FEEDBACK DATA COLLECTION ASSOCIATED WITH CONTRIBUTIONS TO SOFTWARE PLATFORM DEVELOPMENT

(71) Applicant: Capital One Services, LLC, McLean, VA (US)

(72) Inventors: Sameer BANSAL, Mclean, VA (US); Kristaps T. BERZINCH, Arlington, VA (US); Mia Faye BENDY, Chicago, IL (US); Sudipta Kumar GHOSH, Elk Grove Village, IL (US); Michael P. NEWELL, West Chicago, IL (US)

(21) Appl. No.: 17/935,393

(22) Filed: Sep. 26, 2022

(51) Int. Cl. G06Q 10/06; G06F 8/71; G06F 8/77

(52) U.S. Cl. CPC G06Q 10/0639; G06F 8/71; G06F 8/77

(57) ABSTRACT

In some implementations, a server device may receive an indication of a merge operation for source code associated with the software platform and a source code repository associated with the software platform. The server device may identify communication addresses associated with respective users from one or more users associated with the merge operation. The server device may generate feedback survey request data based on roles associated with the respective users. The server device may transmit, to the communication addresses, the feedback survey request data based on receiving the indication of the merge operation. The server device may receive feedback data associated with a user in response to the feedback survey request data. The server device may store the feedback data in a database, wherein feedback data is stored in connection with an identifier of the software platform and with an indication of a role of the user.

### BACKGROUND

Software code may include instructions that may be used to control or instruct the operation of one or more processing devices, such as processors, microprocessors, microcontrollers, and/or co-processors, among other examples. In some examples, software development platforms may require the services of numerous software code developers (e.g., contributors) and/or supervisors (e.g., moderators) for periods of time stretching over many months or even years. A software development project may involve several types of tasks, such as coding, writing tests for the code, performing the tests, analyzing the results, and/or debugging, among other examples. In some cases, an entity may use an InnerSource software development strategy. InnerSource is a software development strategy that applies open source best practices to proprietary source code (e.g., an open source policy may be used within an entity for source code to allow different teams or contributors to access and/or modify the source code).

### SUMMARY

Some implementations described herein relate to a system for real-time feedback data collection associated with contributions to a software platform. The system may include one or more memories and one or more processors coupled to the one or more memories. The one or more processors may be configured to receive an indication that changes to source code associated with the software platform have been merged into a source code repository associated with the software platform, wherein the changes to the source code are associated with a pull request submitted by one or more source code contributors, and wherein the pull request is associated with one or more source code moderators. The one or more processors may be configured to identify communication addresses associated with respective source code contributors, from the one or more source code contributors, and associated with respective source code moderators from the one or more source code moderators. The one or more processors may be configured to generate feedback survey request data based on roles associated with the respective source code contributors and roles associated with the respective source code moderators. The one or more processors may be configured to transmit, to the communication addresses, the feedback survey request data within a threshold amount of time after receiving the indication that changes to the source code associated with the software platform have been merged into the source code repository. The one or more processors may be configured to receive feedback data in response to the feedback survey request data. The one or more processors may be configured to store the feedback data in a database, wherein feedback data is stored in connection with an identifier of the software platform and with an indication of a role of a user, from the one or more source code contributors and the one or more source code moderators, that provided the feedback data.

Some implementations described herein relate to a method for real-time feedback associated with contributions to a software platform. The method may include receiving, by a server device, an indication of a merge operation for source code associated with the software platform and a source code repository associated with the software platform, wherein the merge operation is associated with one or more users. The method may include identifying, by the server device, communication addresses associated with respective users from the one or more users. The method may include generating, by the server device, feedback survey request data based on roles associated with the respective users, wherein the feedback survey request data indicates one or more survey questions to be provided to the one or more users. The method may include transmitting, by the server device and to the communication addresses, the feedback survey request data based on receiving the indication of the merge operation. The method may include receiving, by the server device, feedback data associated with a user, from the one or more users, in response to the feedback survey request data. The method may include storing, by the server device, the feedback data in a database, wherein feedback data is stored in connection with an identifier of the software platform and with an indication of a role of the user. The method may include performing, by the server device, an action based on one or more metrics associated with data, including the feedback data, stored in the database, wherein the data is associated with at least one of the software platform or the source code repository.

Some implementations described herein relate to a non-transitory computer-readable medium that stores a set of instructions for a server device. The set of instructions, when executed by one or more processors of the server device, may cause the server device to receive an indication of a merge operation for source code associated with a software platform and a source code repository associated with the software platform, wherein the merge operation is associated with one or more users. The set of instructions, when executed by one or more processors of the server device, may cause the server device to identify communication addresses associated with respective users from the one or more users. The set of instructions, when executed by one or more processors of the server device, may cause the server device to generate feedback survey request data based on roles associated with the respective users, wherein the feedback survey request data indicates one or more survey questions to be provided to the one or more users. The set of instructions, when executed by one or more processors of the server device, may cause the server device to transmit, to the communication addresses, the feedback survey request data based on receiving the indication of the merge operation. The set of instructions, when executed by one or more processors of the server device, may cause the server device to receive feedback data associated with a user, from the one or more users, in response to the feedback survey request data. The set of instructions, when executed by one or more processors of the server device, may cause the server device to store the feedback data in a database, wherein feedback data is stored in connection with an identifier of the software platform and with an indication of a role of the user. The set of instructions, when executed by one or more processors of the server device, may cause the server device to perform an action based on one or more metrics associated with data, including the feedback data, stored in the database, wherein the data is associated with at least one of the software platform or the source code repository.

### BRIEF DESCRIPTION OF THE DRAWINGS

FIGS. 1A-1D are diagrams of an example associated with real-time feedback data collection associated with contributions to software platform development, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with real-time feedback data collection associated with contributions to software platform development, in accordance with some embodiments of the present disclosure.

FIG. 4 is a flowchart of an example process associated with real-time feedback data collection associated with contributions to software platform development, in accordance with some embodiments of the present disclosure.

### DETAILED DESCRIPTION

The following detailed description of example implementations refers to the accompanying drawings. The same reference numbers in different drawings may identify the same or similar elements.

Computer programming is typically a team-based activity, in which the responsibilities for the features and source code necessary to produce a given product (e.g., a software application) are shared among team members. To facilitate this team activity, team members may submit contributions to the product to a distributed version control system. This system may include a codebase that features a full history of the product that is mirrored on every contributor's computer (e.g., a codebase repository). Team members may submit changes to an external repository, which is reviewed before being added to the repository of the codebase. The system may enable automatic management of different branches of the product as well as the merging of different contributions. The team may also utilize one or more issue management and bug-tracking tools. Accordingly, project management for computer programming often involves multiple team members and service providers sharing multiple versions of a single codebase for the project.

Managing and monitoring software platform development may include collecting feedback from contributors (e.g., users who make changes to and/or add source code to a shared codebase) and moderators (e.g., users who supervise and/or review changes to the shared codebase). A contributor may be referred to as a source code contributor herein. Similarly, a moderator may be referred to as a source code moderator herein. Collecting the feedback may be performed by a user (e.g., by requesting the feedback from the contributors and the moderators associated with the software platform development). Manual collection of the feedback may result in inaccurate feedback data because the feedback is provided some time after contributions to the software platform development occurred. However, because the software platform development may be associated with a distributed version control system, multiple teams, and/or an external code repository, it may be difficult for a system to identify relevant users (e.g., contributors and/or moderators) at relevant times (e.g., close to a time at which a contribution to the software platform development is made) for requesting feedback.

For example, changes to the codebase may be performed (e.g., via a moderator and/or a contributor) via an external code repository that is managed by a code repository system. Therefore, a system associated with the software platform development may be unaware of when changes are made to the codebase. As a result, the system may be unable to request feedback from contributors and/or moderators at relevant times. Additionally, because multiple teams, users, contributors, and/or moderators may have access to the codebase in a distributed manner, the system may be unable to identify relevant users (e.g., who recently contributed and/or moderated changes to the codebase) because the user may be associated with different teams and/or have different affiliations than a team or affiliation associated with the system (e.g., because information associated with the user(s) may be stored in a database and/or format that is unknown and/or unrecognizable by the system).

Therefore, current techniques for obtaining feedback are inefficient because feedback may not be obtained from relevant users at relevant times. As a result, the current techniques for obtaining feedback result in the consumption of computing resources (e.g., processing resources, memory resources, communication resources, and/or the like), networking resources, and/or other resources associated with executing and/or processing source code that is poorly or incorrectly coded, inadequately reviewed, associated with poor processes, documentation, and/or other supporting information, among other examples. For example, because of the inefficient collection of feedback associated with a software platform, devices in a network may consume computing resources (e.g., processing resources, memory resources, communication resources, and/or the like), networking resources, and/or other resources associated with executing and/or processing source code that is of poor quality, inefficient, and/or associated with a poor software platform, among other examples.

Some implementations described herein enable real-time feedback data collection associated with contributions to software platform development. For example, a device may cause a request for feedback data to be automatically provided to communication addresses (e.g., emails, phone numbers, and/or messenger accounts) based on detecting that a merge operation associated with a source code repository has been performed. For example, the device may be enabled to communicate with a code repository system. The device may receive an indication that a merge operation associated with a source code repository has been performed (e.g., an indication that changes to source code associated with the software platform have been merged into a source code repository associated with the software platform). For example, the merge operation and/or the changes may be associated with a pull request (e.g., a request for changes committed to an external repository for an individual project or the platform itself to be considered for inclusion in the platform's main code repository) submitted by one or more source code contributors. After the changes indicated by the pull request are merged into the main code repository, the device may automatically identify communication addresses associated with respective source code contributors and associated with respective source code moderators associated with the pull request.

The device may generate feedback survey request data based on roles associated with the respective source code contributors and roles associated with the respective source code moderators (e.g., separate feedback survey questions for each user associated with the pull request). The device may transmit, to the communication addresses, the feedback survey request data (e.g., within a threshold amount of time) after receiving the indication that changes to the source code associated with the software platform have been merged into the source code repository. The device may receive feedback data in response to the feedback survey request data. The device may store the feedback data in a database. In some implementations, the feedback data is stored in connection with an identifier of the software platform and with an indication of a role of a user, from the one or more source code contributors and the one or more source code moderators, that provided the feedback data.

By using the merge operation as a trigger to provide feedback survey request data, the device may ensure that feedback is requested from users at a relevant time (e.g., close to a time at which the users performed work on source code associated with a code repository). This may improve access to feedback data (and/or a quality of feedback data) because users may be more likely to provide data closer to the time at which the users performed work on source code (e.g., because interactions and/or an experience may be fresh in the user's mind). Additionally, by requesting feedback in real-time by using the merge operation as a trigger, an accuracy of the feedback data may be improved because users may provide the feedback closer to the time at which the users performed work on source code.

Further, the feedback collection process described herein may provide on-demand access to feedback data that is obtained in real-time for software platform development. This may enable a device to correct and/or address issues associated with a software platform in real-time (or near real-time). As a result, the device (e.g., executing and/or processing source code associated with the software platform) may conserve computing resources (e.g., processing resources, memory resources, communication resources, and/or the like), networking resources, and/or other resources that would have otherwise been used (e.g., if feedback were not collected in real-time) associated with executing and/or processing source code that is poorly or incorrectly coded, inadequately reviewed, associated with poor processes, documentation, and/or other supporting information, among other examples.

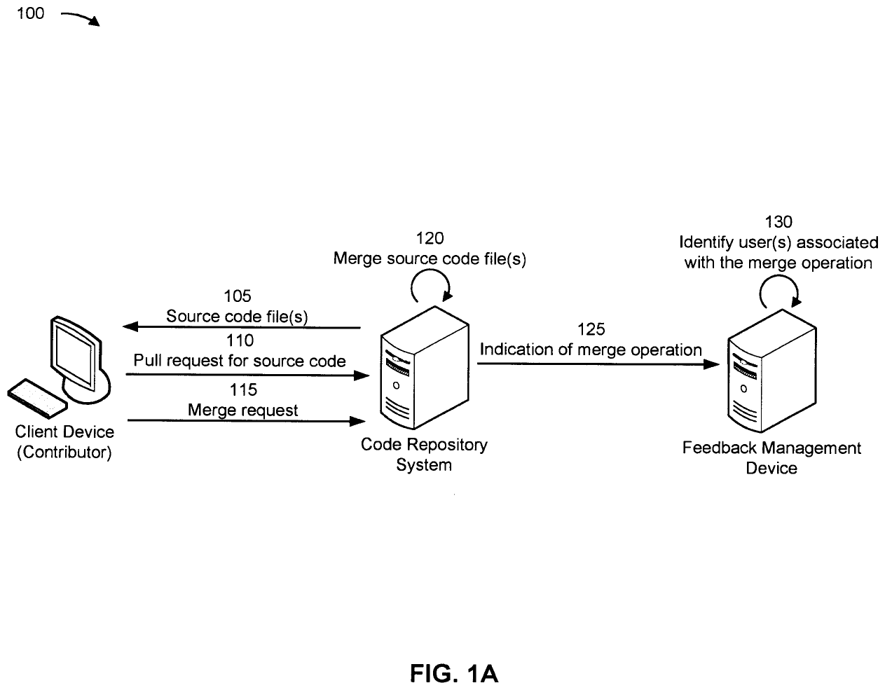

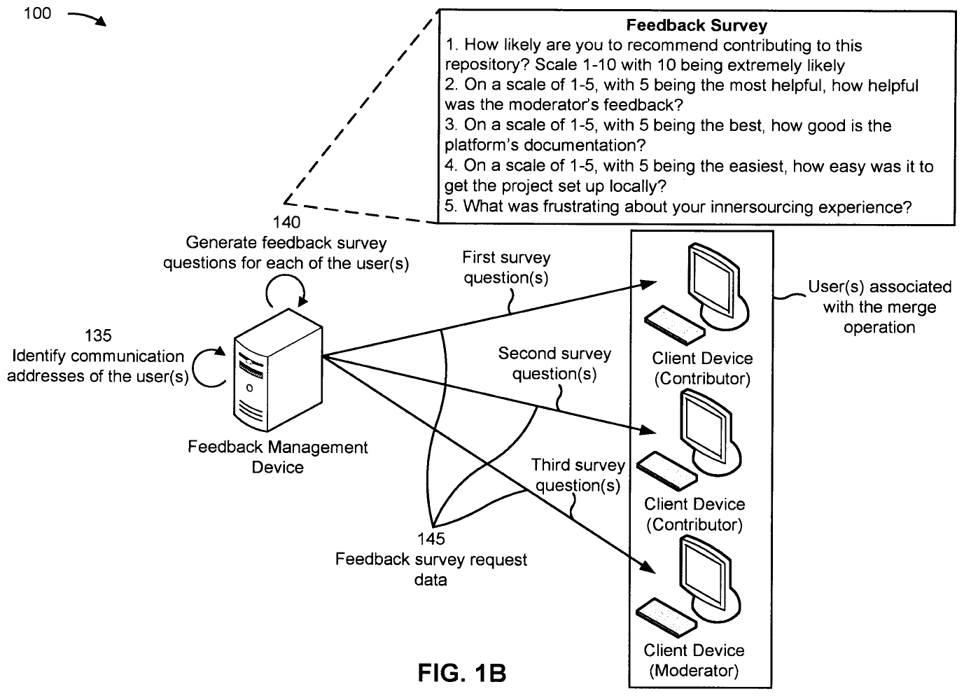

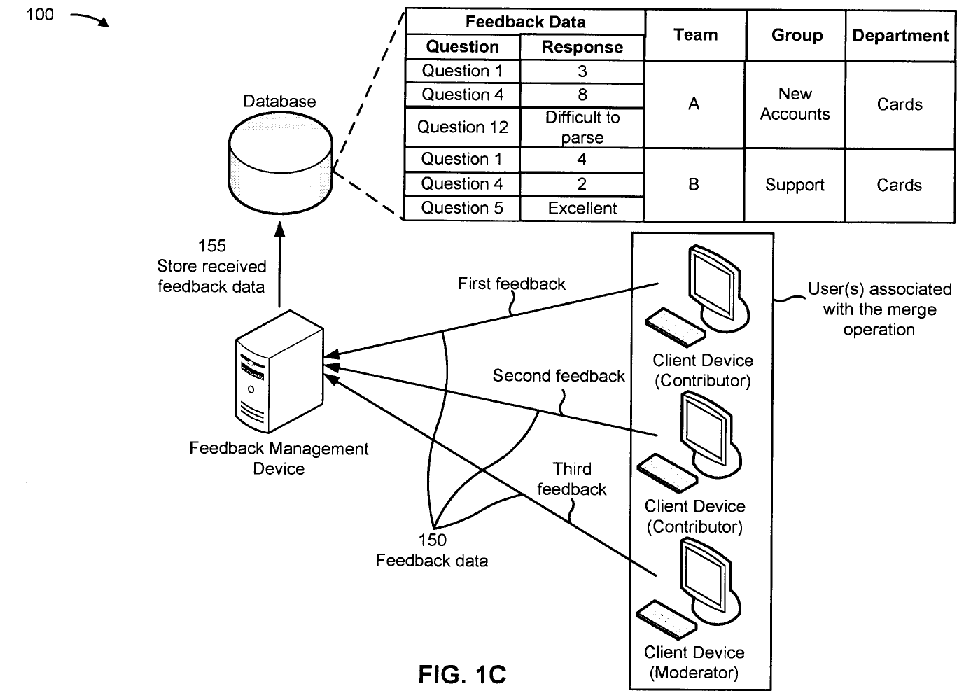

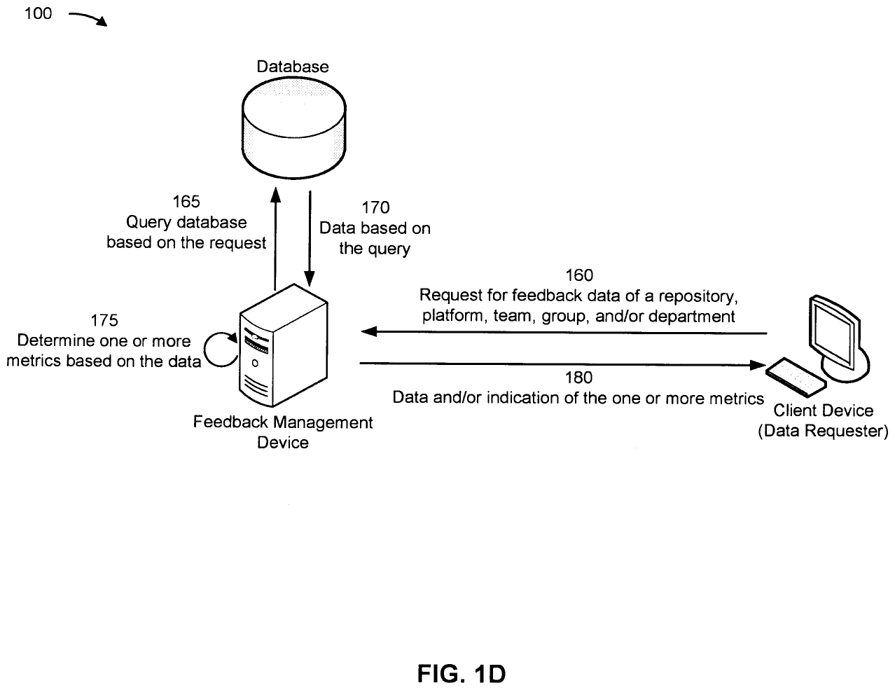

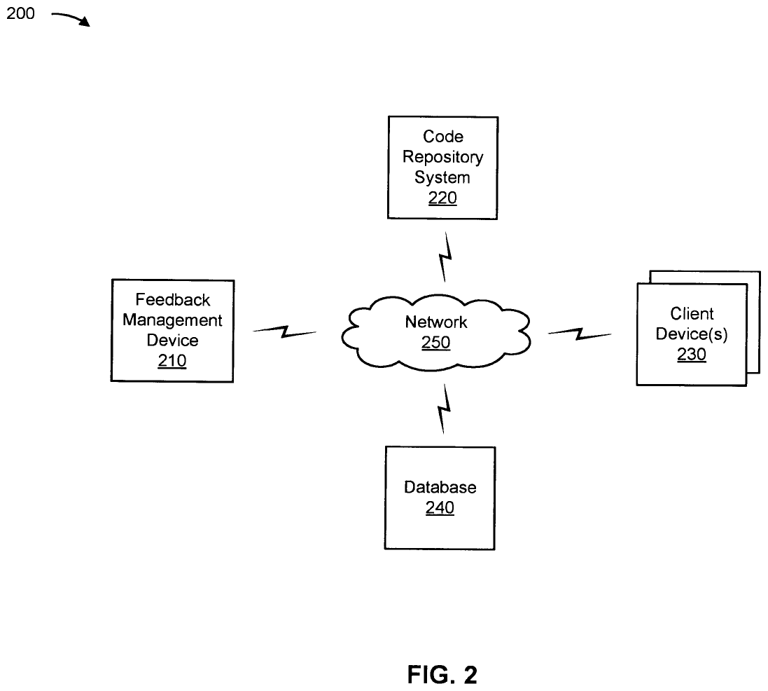

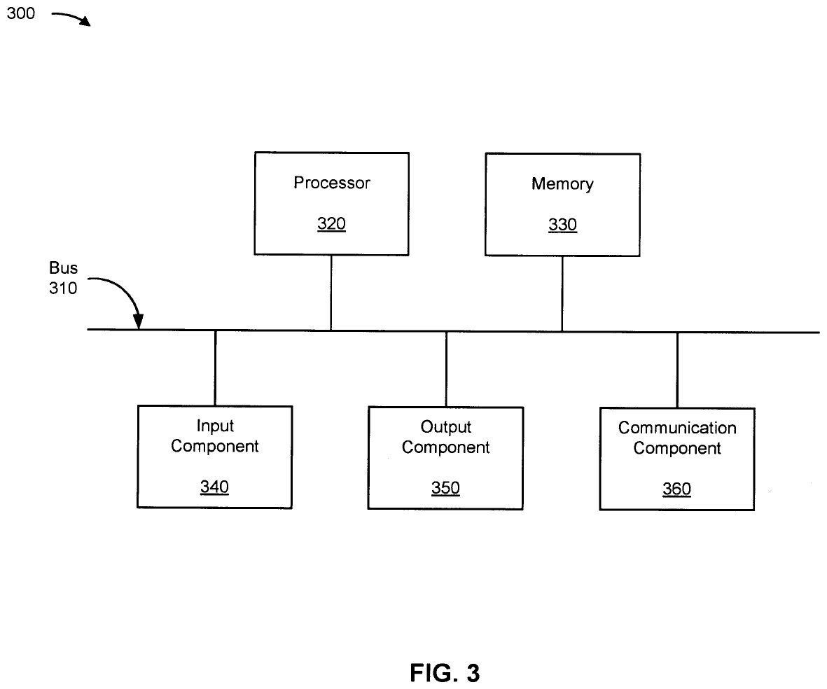

FIGS. 1A-1D are diagrams of an example 100 associated with real-time feedback data collection associated with contributions to software platform development. As shown in FIGS. 1A-1D, example 100 includes a feedback management device, a code repository system, one or more client devices, and a database. These devices are described in more detail in connection with FIGS. 2 and 3.

As shown in FIG. 1A, a client device may communicate with the code repository system to access and/or interact with source code associated with a platform, product, and/or application, among other examples. For example, the code repository system may provide a user interface for display via the client device. The user interface may include a plurality of tasks that need to be completed for a project and/or platform. As described herein, a project may include any individual or collaborative enterprise that is carefully planned and designed to achieve a particular goal. In some implementations, the project may include a source code programming or other project related to the development of software or a computer-based feature. The project may also include multiple components, one or more of which may be based on programming source code, non-source code programming, and/or other development goals. Each project may include one or more contributors that submit contributions to the goal of the project. For example, the project may include the development of a computer feature and/or the contributors to the project may be linked together through a common entity (e.g., a company) or organized in a distributed fashion (e.g., a crowd-sourced project). The project may be distinguished from other projects based on a stated goal, time period, and/or the constituency of contributors. As described herein, a platform may include a computing platform or digital platform environment via which software is executed. A platform may include the hardware, operating system (OS), a web browser and associated application programming interfaces, or other underlying software via which program code is executed.

In some implementations, one or more contributions to a software platform development may correspond to one or more projects/platforms and/or may further correspond to one or more platform development tools. For example, the code repository system may receive contributions from one or more platform development tools. Each platform development tool may provide a service that furthers a goal of the platform development tool. For example, a platform development tool may include a software-as-a-service provider that provides technical management support, such as information technology (IT) service management, to the IT operations of large corporations, including providing help desk functionality. In another example, the platform development tool may include a site that provides social networking-like functions such as feeds, followers, and/or a social network graph to display how developers work on their versions (“forks”) of a repository and what fork (and branch within that fork) is newest. In another example, the platform development tool may include a service for hosting code snippets for small and/or large projects. In another example, the platform development tool may include a service used for issue tracking and project management.

As shown by reference number 105, the code repository system may transmit, and the client device may receive, one or more source code files (e.g., in response to the pull request). One or more contributors may make updates to source code included in the one or more source code files via one or more client devices. For example, the one or more source code files may be stored in an external code repository (e.g., external to the code repository system) to enable the one or more contributors to access and/or make updates to a copy of the source code (e.g., before the updates are merged into the source code repository of the source code that is stored by the code repository system).

As shown by reference number 110, the client device may transmit, and the code repository system may receive, a pull request. The pull request may be associated with accessing source code stored by the code repository system (e.g., in a code repository associated with a product, platform, and/or application). A pull request may be submitted by a contributor (e.g., a user who wishes to change, modify, and/or add to the source code) via the client device. For example, a pull request may be associated with updates to source code made by the contributor. After a pull request is submitted to the code repository system, a moderator (e.g., a user and/or automation tool that reviews updates to the source code) may discuss and review the potential changes with contributors and add follow-up comments before the contribution's changes are merged into the codebase. In some implementations, the moderator may provide an input to the code repository system indicating that the contributor is permitted to access the source code.

In some implementations, the pull request may include an indication of one or more users (e.g., contributors) associated with the pull request, an affiliation of the one or more users, a team associated with the one or more users, a department associated with the one or more users, an entity associated with the one or more users, and/or a stakeholder associated with the one or more users, among other examples. This may enable the feedback management device to identify options for obtaining feedback and/or data analytics at a different affiliation levels, as explained in more detail elsewhere herein. For example, this may enable the feedback management device to identify who (and what group affiliations) are building the software platform and when contributions associated with particular users are made.

As shown by reference number 115, the client device may transmit, and the code repository system may receive a merge request. For example, the one or more contributors (e.g., via the client device) may request that updates to the source code be merged into the source code stored by the code repository system. In some implementations, one or more moderators may review the updates or changes to the source code before the modified source code is merged into the code repository. For example, a moderator (e.g., via a client device not shown in FIG. 1A) may review the modified source code submitted by the one or more contributors. The moderator may provide (e.g., via a client device) comments associated with the modified source code, suggest or make changes to the modified source code, and/or discuss the modified source code with the one or more contributors, among other examples, before the modified source code is merged into a codebase of the code repository. In some implementations, one or more moderators may provide (e.g., via one or more client devices) an indication that the modified source code submitted via the one or more contributors is approved to be merged into the codebase associated with the source code repository (e.g., that is stored by the code repository system).

As shown by reference number 120, the code repository system may merge the modified source code into a codebase of the code repository stored by the code repository system. For example, based on receiving an approval (e.g., from one or more moderators) associated with modified source code submitted as part of a pull request, the code repository system may merge the modified source code into the codebase. For example, the code repository system may perform a merge operation associated with merging the modified source code into the codebase. The merge operation may include merging changes to source code associated with the software platform into the source code repository associated with the software platform. In other words, the merge operation may be a final step in a collaborative contribution process for updating or modifying the codebase (e.g., a final step in an InnerSource technique utilized to update the codebase). For example, the software platform may be associated with an InnerSource operation for development of a codebase associated with the software platform.

As shown by reference number 125, the code repository system may transmit, and the feedback management device may receive, an indication of the merge operation. For example, the feedback management device may receive an indication of a merge operation for source code associated with the software platform and a source code repository associated with the software platform. In other words, the feedback management device may receive an indication that changes to the source code associated with the software platform have been merged into the source code repository associated with the software platform. The code repository system may be configured to provide an indication of completed merge operations to the feedback management device. For example, the code repository system may automatically transmit, to the feedback management device, an indication that the merge operation has been completed.

For example, the code repository system (e.g., a web page or web application of the code repository system) may be configured with a custom callback (e.g., via an application programming interface (API) or webhook). For example, the custom callback may be maintained, modified, and managed by the feedback management device (e.g., and may not be managed by the code repository system and/or an entity associated with the code repository system). For example, the code repository system may provide a web page or a web application associated with an internet hosting service for software development and version control, such as via Git software. The web page or the web application may be configured with a callback (e.g., a webhook) that causes an indication (e.g., a message or communication) to be transmitted to the feedback management device each time a merge occurs associated with one or more code repositories that are managed using the web page or a web application provided by the code repository system.

For example, the feedback management device may transmit, and the code repository system may receive, a configuration indicating parameters associated with the callback. The parameters may indicate how the callback is to be provided, when the callback is to be provided, and/or what information is to be included in the callback. For example, the feedback management device may indicate that the code repository system is to provide indications of completed merge operations for one or more code repositories (e.g., the feedback management device may indicate identifiers associated with the one or more code repositories). In some implementations, the feedback management device may indicate that the code repository system is to provide an indication of users who contributed to the modified source code associated with a given merge operation.

For example, the feedback management device may indicate that the code repository system is to provide an indication of user accounts (e.g., user accounts with the code repository system or with the web page or web application provided by the code repository system) that contributed to operations associated with the merge operation. For example, the feedback management device may indicate that the code repository system is to provide an indication of user accounts associated with a pull request associated with the merge operation. In some implementations, the feedback management device may indicate that the code repository system is to provide an indication of communication addresses associated with the indicated user accounts (e.g., email addresses, phone numbers, and/or other communication addresses provided as part of a registration of the user accounts).

In some implementations, the feedback management device may indicate that the code repository system is to provide an indication of affiliations associated with the merge operation (e.g., affiliations associated with an entity that is associated with the feedback management device). Additionally, or alternatively, the feedback management device may receive, from another device or a database, an indication of affiliations associated with the merge operation. For example, the entity that is associated with the feedback management device may be associated with structure that include one or more users (e.g., contributors and/or moderators), one or more groups (e.g., that include multiple users), one or more teams (e.g., that include one or more groups), and/or one or more departments (e.g., that include multiple teams), among other examples. For example, the entity may be associated with a hierarchical structure or hierarchical organization. As described above, a pull request provided to the code repository system may include an indication of one or more affiliations associated with the pull request (e.g., group(s), team(s), and/or department(s)). The feedback management device may indicate that the code repository system is to provide an indication of the indicated affiliations associated with the merge operation (e.g., associated with one or more pull requests that are associated with the merge operation).

The feedback management device may receive an indication of the one or more pull requests that are associated with the merge operation. In some implementations, the feedback management device may receive an indication of one or more users that are associated with the merge operation and/or the one or more pull requests. For example, the feedback management device may receive an indication of one or more source code contributors and/or one or more source code moderators associated with the merge operation.

As shown by reference number 130, the feedback management device may identify one or more users associated with the merge operation. For example, the feedback management device may identify one or more source code contributors and/or one or more source code moderators that are associated with one or more pull requests that are merged into the codebase. In some implementations, the feedback management device may identify the one or more users associated with the merge operation based on the indication received from the code repository system (e.g., received as described above in connection with reference number 120). For example, the callback communication received from the code repository system may include an indication of one or more user accounts (e.g., user accounts registered with the code repository system and/or with a web application provided by the code repository system) associated with one or more pull requests that are associated with the merge operation. For example, the feedback management device may query an employee database using a communication address or a user account indicated by the code repository system to identify an employee of the entity that is associated with the user account.

As shown in FIG. 1B, and by reference number 135, the feedback management device may identify communication addresses associated with respective users from the one or more users associated with the merge operation. A communication address may include an email address, a phone number, and/or a messaging service account identifier, among other examples. The communication addresses may be used by the feedback management device to request real-time feedback associated with an experience associated with the merge operation, as described in more detail elsewhere herein. For example, the feedback management device may identify communication addresses associated with respective source code contributors from the one or more source code contributors associated with the merge operation. Additionally, the feedback management device may identify communication addresses associated with respective source code moderators from the one or more source code moderators associated with the merge operation. The feedback management device may identify the communication addresses based on the indication received from the code repository system (e.g., received as described above in connection with reference number 120).

This may enable the feedback management device to identify the user(s) associated with the merge operation and communication addresses to which feedback survey questions are to be provided in real-time (e.g., close to a time at which the merge operation occurs). This may improve access to feedback data (e.g., because the users may be more willing to provide feedback closer to the time at which the merge operation occurs) and/or increase the accuracy of feedback data obtained (e.g., because the users may have a better recollection of an experience with the code repository and/or the merge operation closer to the time at which the merge operation occurs).

For example, the indication received from the code repository system may indicate communication addresses associated with user accounts that are associated with the merge operation. The feedback management device may identify that the communication addresses associated with user accounts are to be used to request feedback associated with a user experience with the merge operation. As another example, the feedback management device may use the user account and/or communication addresses to perform a lookup operation in a database (e.g., an employee database or a user database associated with the entity that is associated with the feedback management device). For example, the feedback management device may query an employee database using a communication address or a user account indicated by the code repository system to identify an employee of the entity that is associated with the user account (e.g., the user account registered with the code repository system). A record associated with the employee (e.g., an entry in the employee database) may indicate a communication address associated with the employee.

As shown by reference number 140, the feedback management device may generate feedback survey questions for each of the one or more users associated with the merge operation. For example, the feedback management device may generate feedback survey request data based on roles associated with the respective source code contributors and roles associated with the respective source code moderators. For example, the feedback survey questions provided to source code contributor(s) may be different than the feedback survey questions provided to source code moderator(s). The feedback survey request data may indicate one or more survey questions to be provided to the one or more users that are associated with the merge operation.

For example, the feedback management device may store a library of feedback survey questions. In some implementations, the feedback management device may store feedback survey questions associated with moderators and store feedback survey questions associated with contributors. In other words, the feedback survey request data may indicate a first one or more survey questions to be provided to the one or more contributors and a second one or more survey questions to be provided to the one or more moderators.

In some implementations, the feedback management device may randomly select one or more survey questions, from a set of survey questions associated with the role of a user, to be provided to the user. For example, the feedback management device may generate feedback survey questions for each user (e.g., individually) associated with the merge operation. In some implementations, the feedback management device may identify for the role, a first one or more survey questions, from a set of survey questions associated with the role, that are included in all feedback survey request data associated with the role. In other words, in some examples, the first one or more survey questions may be indicated in all feedback surveys associated with a given role (e.g., contributor or moderator).

The feedback management device may randomly select a second one or more survey questions from the set of survey questions associated with the role. For example, the set of survey questions may be stored in a database or library in connection with respective identifiers or index values. The feedback management device may apply a random selection function or a pseudorandom selection function (e.g., a random number generator or a pseudorandom number generator) to select identifiers or index values of survey questions to be provided to a given user of the one or more users associated with the merge operation. By including one or more static feedback survey questions (e.g., the first one or more survey questions) and one or more dynamic feedback survey questions (e.g., the second one or more survey questions), the feedback management device may increase a variety of feedback survey questions provided to different users (e.g., by randomly selecting some of the survey questions) and ensure that important feedback questions are always provided (e.g., by always including the first one or more feedback survey questions) while also not increasing a quantity of feedback survey questions provided to respective users. For example, if a quantity of feedback survey questions is increased (e.g., to increase a variety of feedback survey questions), a given user may be less likely to complete or respond to the survey feedback questions. Therefore, by randomly selecting one or more feedback survey questions, the feedback management device may increase a variety of feedback survey questions provided to different users (e.g., thereby increasing a variety of feedback data obtained for the code repository and/or the merge operation) while also not increasing a quantity of feedback survey questions provided to a given user. Increasing the variety of feedback data obtained for the code repository and/or the merge operation may enable the feedback management device to determine more insightful metrics and/or analytic data from the feedback data, as described in more detail elsewhere herein.

As shown in FIG. 1B, feedback survey questions may include questions associated with gauging an experience of a contributor and/or a moderator when engaging with a given code repository and/or software platform. The feedback data obtained from responses to the feedback survey questions may enable users who manage and/or moderate the code repository and/or software platform to make improvements and/or identify issues with the code repository and/or software platform. For example, survey questions may include rating scale questions (e.g., requesting a response on a scale, such as from 1 to 5 or from 1 to 10, among other examples). Additionally, or alternatively, the survey questions may include multiple choice questions, true-or-false questions (e.g., questions that include response options of “true” and “false”), and/or yes-or-no questions (e.g., questions that include response options of “yes” and “no”), among other examples. Additionally, or alternatively, the survey questions may include open-ended questions that request a user to input a response (e.g., “what was frustrating about your experience?”). In some implementations, the survey questions may include survey questions associated with an experience with an entire platform, with a portion of the platform (e.g., documentation and/or project setup), and/or with a particular user (e.g., a particular moderator), among other examples.

In some implementations, the feedback management device may refrain from generating feedback survey questions for at least one user associated with the merge operation. For example, in some cases, the feedback management device may refrain from generating feedback survey questions for users that moderate and/or manage the code repository and/or the software platform. For example, the feedback management device may refrain from generating feedback survey questions for users that are associated with a team that owns and/or manages the code repository and/or the software platform. For example, as described above, the feedback management device may identify one or more affiliations of users associated with the merge operation. The feedback management device may identify a user that is associated with a team that is associated with the software platform or the source code repository (e.g., that owns or manages the software platform or the source code repository). The feedback management device may determine that the user is not to be included in the one or more users from which feedback is requested. The feedback management device may refrain from generating feedback survey questions for the user based on the user being associated with the team.

For example, feedback from a user included in a team that owns or manages the software platform or the source code repository may not be insightful or valuable (and/or may be inaccurate). For example, a user included in a team that owns or manages the software platform and/or the source code repository may be more likely to provide inaccurate positive feedback to improve statistics of the team and/or a reputation of the team. Therefore, by refraining from generating and/or providing feedback survey questions to users who are included in a team that owns or manages the software platform and/or the source code repository, accuracy of the feedback data obtained by the feedback management device may be improved. Additionally, the feedback management device may conserve processing resources, network resources, and/or computing resources that would have otherwise been used to generate feedback survey questions and transmit an indication of the feedback survey questions to users that may provide inaccurate or less valuable feedback.

As shown by reference number 145, the feedback management device may transmit the feedback survey request data after receiving the indication that changes to the source code associated with the software platform have been merged into the source code repository. For example, the feedback management device may identify a communication address and a set of feedback survey questions generated for a user associated with the merge operation. The feedback management device may transmit, to the communication address, an indication of the set of feedback survey questions generated for a user. For example, as shown in FIG. 1B, the feedback management device may transmit a first one or more survey questions to a first client device associated with a first user (e.g., a contributor). The feedback management device may transmit a second one or more survey questions to a second client device associated with a second user (e.g., a contributor). The feedback management device may transmit a third one or more survey questions to a third client device associated with a third user (e.g., a moderator).

In some implementations, the feedback management device may transmit the indications of the feedback survey questions in real-time after the users contribute to the source code repository and/or the software platform. In other words, the feedback management device may transmit the indications of the feedback survey questions close to a time at which the users contribute to the source code repository and/or the software platform. For example, the feedback management device may transmit the indications of the feedback survey questions within a threshold amount of time after receiving the indication that changes to the source code associated with the software platform have been merged into the source code repository. In some implementations, the threshold amount of time may be associated with, or be based on, an amount of time associated with the feedback management device receiving the indication that the merge operation has been completed and with the feedback management device generating the one or more sets of feedback survey questions (e.g., may be associated with, or be based on, an amount of time associated with the operations described in connection with reference numbers 125, 130, 135, and 140). This may improve access to feedback data because users may be more likely to provide data closer to the time at which the users performed work on source code (e.g., because interactions and/or an experience may be fresh in the user's mind). Additionally, by requesting feedback in real-time by using the merge operation as a trigger, an accuracy of the feedback data may be obtained because users may provide the feedback closer to the time at which the users performed work on source code.

As shown in FIG. 1C, and by reference number 150, the feedback management device may receive feedback data in response to the feedback survey request data transmitted by the feedback management device. For example, the feedback management device may receive, from a client device associated with a given user, one or more responses to feedback survey questions provided to the client device. For example, the feedback management device may receive feedback data associated with a user, from the one or more users associated with the merge operation, in response to the feedback survey request data.

A user (e.g., a contributor or a moderator) may access the feedback survey questions via a client device. The user may input, to the client device, responses to the feedback survey questions. The client device may transmit, to the feedback management device, an indication of the responses. For example, the feedback data, for a given user, may include an indication of the responses to the feedback survey questions that were provided to the given user.

As shown by reference number 155, the feedback management device may store the feedback data (e.g., received from one or more client devices) in a database. In some implementations, the feedback management device may store the feedback data in connection with an identifier of the software platform and/or with an indication of a role (e.g., contributor or moderator) of the user that provided the feedback data. The feedback management device may not store an indication of the given user that provided the feedback data (e.g., may not store a name of the user, an identifier of the user, and/or a communication address of the user). In this way, the feedback data, as stored by the feedback management device, may be anonymous (e.g., to prevent retaliations from other users due to negative feedback that is provided).

As shown in FIG. 1C, the feedback data may be stored (e.g., by the feedback management device) in connection with one or more affiliations of a user who provided the feedback data and/or one or more affiliations of a user, team, or group to which the feedback data is relevant. For example, the source code repository and/or the software platform may be associated with one or more affiliations (e.g., a group affiliation, a team affiliation, and/or a department affiliation). The feedback management device may store feedback data in connection with one or more affiliations relevant to the feedback data (e.g., the one or more affiliations associated with the source code repository and/or the software platform). This may enable the feedback management device to aggregate feedback data for a given affiliation across multiple merge operations and/or multiple experiences (e.g., to aggregate all feedback data stored in the database associated with a given group, team, and/or department).

In some implementations, the feedback management device may store feedback data in connection with an indication of a portion or a part of the code repository and/or software platform. For example, a given survey question may be specific to a portion or a part of the code repository and/or software platform (e.g., supporting documentation, portability, and/or difficulty to install on a local machine (e.g., on a client device)). The feedback management device may store an indication to a response to a feedback survey question in connection with an indication of a portion or a part of the code repository and/or software platform that is associated with the feedback survey question. This may enable the feedback management device to quickly aggregate feedback data associated with a portion or a part of the code repository and/or software platform. In some implementations, the feedback management device may store feedback data in connection with an indication of a user (e.g., a contributor or a moderator). For example, a feedback survey question may request feedback on a given user (e.g., “how helpful was the moderator's feedback on a scale of 1 to 10?”). The feedback management device may store an indication to a response to a feedback survey question in connection with an indication of the user. This may enable the feedback management device to quickly aggregate feedback data relevant to a particular user.

As shown in FIG. 1D, and as shown by reference number 160, the feedback management device may receive (e.g., from a client device) a request for feedback data. For example, the request may be for data associated with the software platform or the source code repository. Additionally, or alternatively, the request may be for data associated with a user, a group, a team, and/or a department, among other examples. For example, the request may indicate the software platform, the source code repository, and/or one or more affiliations, among other examples.

The feedback management device may obtain, via the database, the data based on receiving the request. For example, as shown by reference number 165, the feedback management device may query the database using an identifier associated with the software platform, the source code repository, and/or the one or more affiliations indicated by the request. In other words, the feedback management device may search the database for feedback data associated with the software platform, the source code repository, and/or the one or more affiliations indicated by the request. As shown by reference number 170, the feedback management device may obtain data based on the query and/or the search. For example, the feedback management device may obtain an indication of entries and/or data indicated by entries that are associated with, or tagged with, an identifier associated with the software platform, the source code repository, and/or the one or more affiliations indicated by the request.

As shown by reference number 175, the feedback management device may aggregate the data to determine one or more metrics associated with the data. For example, the feedback management device may combine the data returned as part of the query or search of the database. In some implementations, the feedback management device may aggregate the feedback data according to survey questions associated with the feedback data. For example, the feedback management device may aggregate feedback data obtained based on querying or searching the database that is associated with a given feedback survey question. The feedback management device may determine one or more metrics based on the aggregated feedback data. In some implementations, the one or more metrics may include a net promoter score (e.g., that is based on a feedback survey question of “how likely would you be to recommend contributing to this repository on a scale of 1 to 10?” or similar feedback survey questions). Additionally, or alternatively, the one or more metrics may include an average response (e.g., on a scale) to one or more feedback survey questions.

In some implementations, the feedback management device may analyze open-ended responses provided as responses to an open-ended feedback survey question. For example, the feedback management device may use a natural language processing (NLP) technique or another technique to analyze responses provided as responses to an open-ended feedback survey question. For example, the feedback management device may determine a score (e.g., on a scale) based on analyzing a response to an open-ended feedback survey question. As an example, the feedback management device may identify certain keywords within a response to an open-ended feedback survey question. For example, words such as good, excellent, great, easy, wonderful, and/or similar words may indicate a higher score on the scale (e.g., if a higher score is associated with a positive experience) and words such as terrible, awful, bad, horrible, hard, difficult, and/or similar words may indicate a lower score on the scale (e.g., if a lower score is associated with a negative experience). This may enable the feedback management device to provide a numerical representation of written responses provided to an open-ended feedback survey question. This may provide valuable insight for analyzing or comparing the feedback provided to open-ended feedback survey questions to feedback provided to closed-ended feedback survey questions.

In some implementations, the feedback management device may periodically aggregate feedback data in a similar manner as described above. For example, the feedback management device may periodically collect and/or analyze feedback data for a software platform, a source code repository, and/or one or more affiliations, among other examples. For example, the feedback management device may be configured (e.g., by a client device) to periodically aggregate and analyze feedback data. For example, the feedback management device may be configured (e.g., by a client device) to periodically aggregate and analyze feedback data without receiving a request from a client device.

In some implementations, the feedback management device may perform an action based on the one or more metrics (e.g., calculated in response to the request or calculated without a request by the feedback management device) associated with the aggregated feedback data. For example, as shown by reference number 180, the action may include transmitting, to the client device, an indication of the aggregated data and/or an indication of the one or more metrics (e.g., in response to the request).

In some implementations, such as where the feedback management device periodically aggregates and analyzes feedback data without receiving a request from a client device, the action may include transmitting, to the client device, an indication of the aggregated data and/or an indication of the one or more metrics based on a value of a metric satisfying a threshold. For example, if a value (e.g., a net promoter score or an average value (on a scale) of a response to a feedback survey question) satisfies a threshold (e.g., indicating a negative or poor experience), then the feedback management device may automatically transmit, to the client device, an indication of the aggregated data and/or an indication of the one or more metrics. For example, the feedback management device may transmit an indication of the one or more metrics to a management account associated with the software platform. As another example, the feedback management device may periodically (e.g., based on a periodic schedule) transmit an indication of the one or more metrics to the management account.

As another example, the action may include opening a work item ticket via a service desk application. For example, the feedback management device may determine that a value (e.g., a net promoter score or an average value (on a scale) of a response to a feedback survey question) satisfies a threshold. The feedback management device may automatically open a work item ticket via a service desk application based on the value satisfying the threshold (e.g., to cause an employee or a user to investigate an issue indicated by the work ticket item).

By using the merge operation as a trigger to provide feedback survey request data, the device may ensure that feedback is requested from users at a relevant time (e.g., close to a time at which the users performed work on source code associated with a code repository). This may improve access to feedback data because users may be more likely to provide data closer to the time at which the users performed work on source code (e.g., because interactions and/or an experience may be fresh in the user's mind). Additionally, by requesting feedback in real-time by using the merge operation as a trigger, an accuracy of the feedback data may be obtained may be improved because users may provide the feedback closer to the time at which the users performed work on source code.

Further, the feedback collection process described herein may provide on-demand access to feedback data that is obtained in real-time for software platform development. This may enable a device to correct and/or address issues associated with a software platform in real-time (or near real-time). As a result, the device (e.g., executing and/or processing source code associated with the software platform) may conserve computing resources (e.g., processing resources, memory resources, communication resources, and/or the like), networking resources, and/or other resources that would have otherwise been used (e.g., if feedback were not collected in real-time) associated with executing and/or processing source code that is poorly or incorrectly coded, inadequately reviewed, associated with poor processes, documentation, and/or other supporting information, among other examples.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a feedback management device 210, a code repository system 220, one or more client devices 230, a database 240, and a network 250. Devices of environment 200 may interconnect via wired connections, wireless connections, or a combination of wired and wireless connections.

The feedback management device 210 may include one or more devices capable of receiving, generating, storing, processing, providing, and/or routing information associated with real-time feedback data collection associated with contributions to software platform development, as described elsewhere herein. The feedback management device 210 may include a communication device and/or a computing device. For example, the feedback management device 210 may include a server, such as an application server, a client server, a web server, a database server, a host server, a proxy server, a virtual server (e.g., executing on computing hardware), or a server in a cloud computing system. In some implementations, the feedback management device 210 may include computing hardware used in a cloud computing environment.

The code repository system 220 may include one or more devices capable of receiving, generating, storing, processing, providing, and/or routing information associated with real-time feedback data collection associated with contributions to software platform development, as described elsewhere herein. The code repository system 220 may include one or more devices capable of storing and/or managing access to one or more code repositories. The code repository system 220 may include a communication device and/or a computing device. For example, the code repository system 220 may include a server, such as an application server, a client server, a web server, a database server, a host server, a proxy server, a virtual server (e.g., executing on computing hardware), or a server in a cloud computing system. In some implementations, the code repository system 220 may include computing hardware used in a cloud computing environment.

The client device 230 may include one or more devices capable of receiving, generating, storing, processing, and/or providing information associated with real-time feedback data collection associated with contributions to software platform development, as described elsewhere herein. The client device 230 may include a communication device and/or a computing device. For example, the client device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The database 240 may include one or more devices capable of receiving, generating, storing, processing, and/or providing information associated with real-time feedback data collection associated with contributions to software platform development, as described elsewhere herein. The database 240 may include a communication device and/or a computing device. For example, the database 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the database 240 may store feedback data, as described elsewhere herein.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with real-time feedback data collection associated with contributions to software platform development. The device 300 may correspond to the feedback management device 210, the code repository system 220, the one or more client devices 230, and/or the database 240, among other examples. In some implementations, the feedback management device 210, the code repository system 220, the one or more client devices 230, and/or the database 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator, among other examples. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

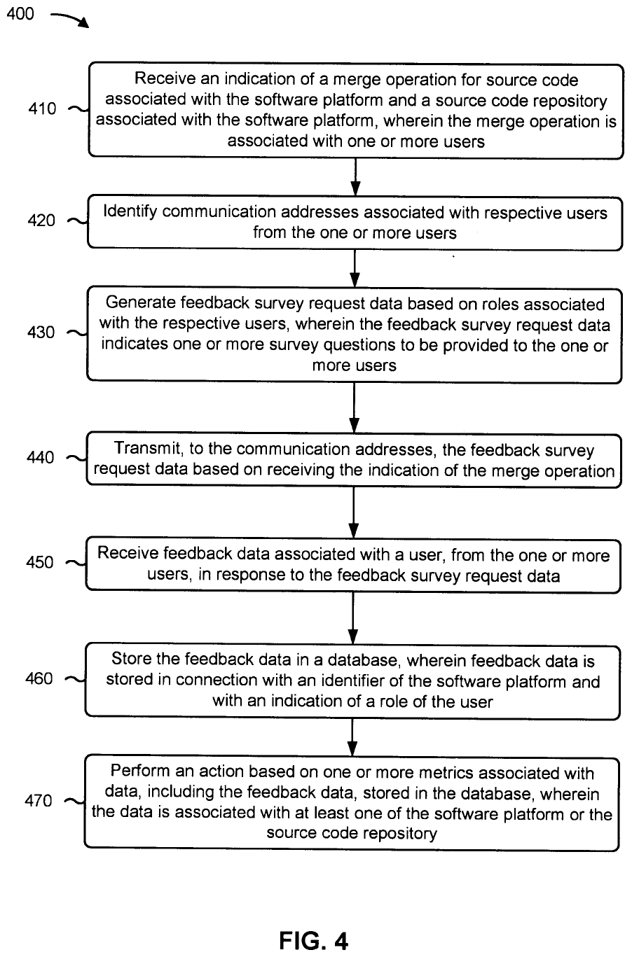

FIG. 4 is a flowchart of an example process 400 associated with real-time feedback data collection associated with contributions to software platform development. In some implementations, one or more process blocks of FIG. 4 may be performed by the feedback management device 210. In some implementations, one or more process blocks of FIG. 4 may be performed by another device or a group of devices separate from or including the feedback management device 210, such as the code repository system 220, a client device 230, and/or the database 240, among other examples. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving an indication of a merge operation for source code associated with the software platform and a source code repository associated with the software platform, wherein the merge operation is associated with one or more users (block 410). For example, the feedback management device 210 (e.g., using processor 320, memory 330, input component 340, and/or communication component 360) may receive an indication of a merge operation for source code associated with the software platform and a source code repository associated with the software platform, wherein the merge operation is associated with one or more users, as described above in connection with reference number 125 of FIG. 1A. As an example, the feedback management device 210 may receive an indication (e.g., from the code repository system 220) each time a merge associated with a pull request is completed for a given code repository.

As further shown in FIG. 4, process 400 may include identifying communication addresses associated with respective users from the one or more users (block 420). For example, the feedback management device 210 (e.g., using processor 320 and/or memory 330) may identify communication addresses associated with respective users from the one or more users, as described above in connection with reference number 135 of FIG. 1B. As an example, the indication of the merge associated with a pull request (e.g., received from the code repository system 220) may include an indication of user accounts (e.g., registered with the code repository system 220) that are associated with the merge operation. The feedback management device 210 may identify the communication addresses based on information associated with the user accounts (e.g., an email associated with the user account).

As further shown in FIG. 4, process 400 may include generating feedback survey request data based on roles associated with the respective users, wherein the feedback survey request data indicates one or more survey questions to be provided to the one or more users (block 430). For example, the feedback management device 210 (e.g., using processor 320 and/or memory 330) may generate feedback survey request data based on roles associated with the respective users, wherein the feedback survey request data indicates one or more survey questions to be provided to the one or more users, as described above in connection with reference number 140 of FIG. 1B. As an example, the feedback management device 210 may select one or more survey questions from a library of survey questions that is associated with a role of a user that is associated with the merge operation.

As further shown in FIG. 4, process 400 may include transmitting, to the communication addresses, the feedback survey request data based on receiving the indication of the merge operation (block 440). For example, the feedback management device 210 (e.g., using processor 320, memory 330, and/or communication component 360) may transmit, to the communication addresses, the feedback survey request data based on receiving the indication of the merge operation, as described above in connection with reference number 145 of FIG. 1B. As an example, the feedback management device 210 may transmit an indication of one or more feedback survey questions to the one or more users associated with the merge operation (e.g., in real-time shortly after receiving the indication of the merge operation).

As further shown in FIG. 4, process 400 may include receiving feedback data associated with a user, from the one or more users, in response to the feedback survey request data (block 450). For example, the feedback management device 210 (e.g., using processor 320, memory 330, input component 340, and/or communication component 360) may receive feedback data associated with a user, from the one or more users, in response to the feedback survey request data, as described above in connection with reference number 150 of FIG. 1C. As an example, the feedback management device 210 may receive responses to feedback survey questions provided by at least one of the one or more users associated with the merge operation.

As further shown in FIG. 4, process 400 may include storing the feedback data in a database, wherein feedback data is stored in connection with an identifier of the software platform and with an indication of a role of the user (block 460). For example, the feedback management device 210 (e.g., using processor 320 and/or memory 330) may store the feedback data in a database, wherein feedback data is stored in connection with an identifier of the software platform and with an indication of a role of the user, as described above in connection with reference number 155 of FIG. 1C. As an example, the feedback management device 210 may store an indication of responses, provided by a user, with one or more tags indicating the software platform, a role of the user, and/or one or more affiliations associated with the software platform, among other examples.

As further shown in FIG. 4, process 400 may include performing an action based on one or more metrics associated with data, including the feedback data, stored in the database, wherein the data is associated with at least one of the software platform or the source code repository (block 470). For example, the feedback management device 210 (e.g., using processor 320 and/or memory 330) may perform an action based on one or more metrics associated with data, including the feedback data, stored in the database, wherein the data is associated with at least one of the software platform or the source code repository, as described above in connection with reference numbers 165, 170, 175, and/or 180 of FIG. 1D. As an example, the feedback management device 210 may aggregate feedback data stored in the database. The feedback management device may determine the one or more metrics based on the aggregated feedback data. For example, the one or more actions may include transmitting an indication of the aggregated feedback data or the one or more metrics to a management account, and/or opening a work item ticket, among other examples.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for real-time feedback data collection associated with contributions to a software platform, the system comprising:
one or more memories; and
one or more processors, coupled to the one or more memories, configured to:
receive an indication that changes to source code associated with the software platform have been merged into a source code repository associated with the software platform, wherein the changes to the source code are associated with a pull request submitted by one or more source code contributors, and wherein the pull request is associated with one or more source code moderators;
identify communication addresses associated with respective source code contributors, from the one or more source code contributors, and associated with respective source code moderators from the one or more source code moderators;
generate feedback survey request data based on roles associated with the respective source code contributors and roles associated with the respective source code moderators;
transmit, to the communication addresses, the feedback survey request data within a threshold amount of time after receiving the indication that changes to the source code associated with the software platform have been merged into the source code repository;
receive feedback data in response to the feedback survey request data; and
store the feedback data in a database, wherein feedback data is stored in connection with an identifier of the software platform and with an indication of a role of a user, from the one or more source code contributors and the one or more source code moderators, that provided the feedback data.

2. The system of claim 1, wherein the one or more processors are further configured to:
aggregate feedback data, from the database, that is associated with the software platform;
determine one or more metrics based on the aggregated feedback data; and
perform an action based on the one or more metrics.

3. The system of claim 2, wherein the action includes at least one of:
opening a work item ticket via a service desk application, or
transmitting an indication of the one or more metrics to a management account associated with the software platform.

4. The system of claim 1, wherein the feedback survey request data includes:
an indication of a first one or more survey questions to be provided to the one or more source code contributors, and
an indication of a second one or more survey questions to be provided to the one or more source code moderators.

5. The system of claim 1, wherein the one or more processors, to generate the feedback survey request data, are configured to:
identify, for the role, a first one or more survey questions, from a set of survey questions associated with the role, that are included in all feedback survey request data associated with the role; and
randomly select a second one or more survey questions from the set of survey questions associated with the role, wherein the first one or more survey questions and the second one or more survey questions are indicated by the feedback survey request data.

6. The system of claim 1, wherein the one or more processors are further configured to:
receive a request for data associated with the software platform or the source code repository;
obtain, via the database, the data including the feedback data based on receiving the request;
aggregate the data to determine one or more metrics associated with the data; and
provide, in response to the request, an indication of at least one of the data or the one or more metrics.

7. The system of claim 6, wherein the one or more metrics include a net promoter score.

8. The system of claim 1, wherein the software platform is associated with an InnerSource operation.

9. The system of claim 1, wherein the one or more processors, to store the feedback data, are configured to:
store data, from the feedback data, that is associated with the user, with an indication of at least one of:
a group affiliation,
a team affiliation, or
a department affiliation.

10. A method for real-time feedback associated with contributions to a software platform, comprising:
receiving, by a server device, an indication of a merge operation for source code associated with the software platform and a source code repository associated with the software platform, wherein the merge operation is associated with one or more users;
identifying, by the server device, communication addresses associated with respective users from the one or more users;
generating, by the server device, feedback survey request data based on roles associated with the respective users, wherein the feedback survey request data indicates one or more survey questions to be provided to the one or more users;
transmitting, by the server device and to the communication addresses, the feedback survey request data based on receiving the indication of the merge operation;
receiving, by the server device, feedback data associated with a user, from the one or more users, in response to the feedback survey request data;
storing, by the server device, the feedback data in a database, wherein feedback data is stored in connection with an identifier of the software platform and with an indication of a role of the user; and
performing, by the server device, an action based on one or more metrics associated with data, including the feedback data, stored in the database, wherein the data is associated with at least one of the software platform or the source code repository.

11. The method of claim 10, wherein performing the action comprises:
aggregating the data, from the database, based on querying the database using an indication of the software platform; and
determining the one or more metrics based on the aggregated feedback data.

12. The method of claim 10, wherein performing the action comprises:
transmitting an indication of the one or more metrics to a management account associated with the software platform based on a value of the one or more metrics satisfying a threshold.

13. The method of claim 10, wherein the one or more users include one or more contributors and one or more moderators, and wherein the feedback survey request data includes:
an indication of a first one or more survey questions to be provided to the one or more contributors, and
an indication of a second one or more survey questions to be provided to the one or more moderators.

14. The method of claim 10, wherein generating the feedback survey request data comprises:
randomly selecting one or more survey questions, from a set of survey questions associated with the role of the user, to be provided to the user.

15. The method of claim 10, further comprising:
receiving a request for the data, wherein the request includes an indication of at least one of the software platform or the source code repository;
obtaining, via the database, the data based on receiving the request; and
providing, in response to the request, an indication of at least one of the data or the one or more metrics.

16. The method of claim 10, wherein storing the feedback data comprises:
storing the feedback data, that is associated with the user, with an indication of:
a team affiliation, and
a department affiliation.

17. The method of claim 10, wherein generating the feedback survey request data comprises:
identifying a different user that is associated with the merge operation, wherein the different user is not included in the one or more users based on the different user being associated with a team that is associated with the software platform or the source code repository; and
refraining from generating feedback survey questions for the different user based on the different user being associated with the team.

18. A non-transitory computer-readable medium storing a set of instructions, the set of instructions comprising:
one or more instructions that, when executed by one or more processors of a server device, cause the server device to:
receive an indication of a merge operation for source code associated with a software platform and a source code repository associated with the software platform, wherein the merge operation is associated with one or more users;
identify communication addresses associated with respective users from the one or more users;
generate feedback survey request data based on roles associated with the respective users, wherein the feedback survey request data indicates one or more survey questions to be provided to the one or more users;
transmit, to the communication addresses, the feedback survey request data based on receiving the indication of the merge operation;
receive feedback data associated with a user, from the one or more users, in response to the feedback survey request data;
store the feedback data in a database, wherein feedback data is stored in connection with an identifier of the software platform and with an indication of a role of the user; and
perform an action based on one or more metrics associated with data, including the feedback data, stored in the database, wherein the data is associated with at least one of the software platform or the source code repository.

19. The non-transitory computer-readable medium of claim 18, wherein the one or more instructions, that cause the server device to perform the action, cause the server device to:
transmit an indication of the one or more metrics to a management account associated with the software platform based on a periodic schedule.

20. The non-transitory computer-readable medium of claim 18, wherein the one or more users include one or more contributors and one or more moderators, and wherein the feedback survey request data includes:
an indication of a first one or more survey questions to be provided to the one or more contributors, and
an indication of a second one or more survey questions to be provided to the one or more moderators.
